(19) United States
(12) Patent Application Publication
(10) Pub. No.: US 2016/0330201 A1
(43) Pub. Date: Nov. 10, 2016

(54) Systems and Methods for Controlling Access to a Computer Device

(71) Applicant: Thi Chau Nguyen-Huu, Mississauga (CA)

(72) Inventor: Thi Chau Nguyen-Huu, Mississauga (CA)

(21) Appl. No.: 14/827,805

(22) Filed: Aug. 17, 2015

Related U.S. Application Data
(60) Provisional application No. 62/201,309, filed on Aug. 5, 2015.
(60) Provisional application No. 62/159,094, filed on May 8, 2015.
(60) Provisional application No. 62/170,911, filed on Jun. 4, 2015.

(51) Int. Cl. H04L 29/06; H04L 9/08

(52) U.S. Cl. CPC H04L 63/10; H04L 9/0819

(57) ABSTRACT

A method and system for controlling access to a computer device. The method and system involves operating a computer device to control access to the computer device by a host system. The method comprises determining if the host system is authorized to have access to the computer device; operating the computer device to start a session if and only if the host system is authorized to have access to the computer device; during the session, providing the host system with access to the computer device; operating the computer device to monitor the host system during the session to determine if a session termination event has occurred; and, terminating the session when the session termination event has occurred, wherein terminating the session blocks access to the computer device by the host system.

### RELATED APPLICATIONS

This application claims priority from the U.S. provisional patent application Nos. 62/201,309, filed on Aug. 5, 2015; 62/159,094, filed on May 8, 2015 and 62/170,911, filed on Jun. 4, 2015 entitled “SYSTEMS AND METHODS FOR CONTROLLING ACCESS TO A COMPUTER DEVICE”, the disclosures of which are incorporated herein, in their entirety, by reference.

### FIELD

The described embodiments relate to systems and methods for controlling access to a computer device.

### BACKGROUND

In many situations, individuals and corporations need to securely store electronic data. In some cases, data can be stored on data storage devices that use access passwords to control access to the data. Data on the data storage devices can be vulnerable to a “hot-swap” cable attack. That is, after the data storage device is unlocked, an attacker may unplug the data cable of the data storage device and plug the unlocked data storage device to another computer, or imposter host, to access the data.

### SUMMARY

In accordance with an embodiment of the invention, there is provided a method for operating a computer device to control access to the computer device by a computer system. The method comprises determining if an operating system of the computer system is authorized to have access to the computer device; operating the computer device to start a session if and only if the operating system is authorized to have access to the computer device; during the session, providing the operating system with access to the computer device; operating the computer device to monitor the operating system during the session to determine if a session termination event has occurred; and, terminating the session when the session termination event has occurred, wherein terminating the session blocks access to the computer device by the operating system.

In accordance with an embodiment of the invention, there is provided a system for operating a computer device to control access to the computer device by a computer system. The system comprises a computer device with a processor for determining if an operating system of the computer system is authorized to have access to the computer device; operating the computer device to start a session if and only if the operating system is authorized to have access to the computer device; during the session, providing the operating system with access to the computer device; operating the computer device to monitor the operating system during the session to determine if a session termination event has occurred; and, terminating the session when the session termination event has occurred, wherein terminating the session blocks access to the computer device by the operating system.

### BRIEF DESCRIPTION OF THE DRAWINGS

A preferred embodiment of the present invention will now be described in detail with reference to the drawings, in which:

FIG. 1 is a flowchart illustrating a process for operating a target device to control access to the target device by a host system in accordance with an example embodiment;

FIG. 2 is a flowchart illustrating a process for establishing a heartbeat key in accordance with an example embodiment;

FIG. 3 is a flowchart illustrating a process for exchanging cryptographic heartbeats in accordance with an example embodiment;

FIG. 4 is a flowchart illustrating a process for establishing a heartbeat key with a time limit in accordance with an example embodiment;

FIG. 5 is a flowchart illustrating a process for exchanging cryptographic heartbeats with time limits in accordance with an example embodiment;

FIG. 6 is a flowchart illustrating a process for establishing a heartbeat key with a master heartbeat key in accordance with an example embodiment; and

FIGS. 7-A to 7-C are block diagrams illustrating data transmitted between the host system and the target device in accordance with example embodiments.

FIG. 8 is a block diagram illustrating an example system for controlling access to the target device in accordance with an embodiment.

### DETAILED DESCRIPTION OF EXEMPLARY EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices, in known fashion.

Each program may be implemented in a high level procedural or object oriented programming or scripting language, or both, to communicate with a computer system. Alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions may also be in various forms, including compiled and non-compiled code.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

The various embodiments described herein generally relate to a method (and related system) for operating a computer device to control access to the computer device by a computer system. In at least one embodiment, the computer device can be a data storage device, specifically, a self-encrypting drive (“SED”). Access to the computer device by a computer system, or “authentic” or “authorized” computer system, may be controlled to guard against other computer systems, or “imposters”, from spoofing or masquerading as the authentic computer system. Imposters may pretend to be the authentic system in order to access and obtain protected or sensitive data from the data storage device. Generally, such attacks may be detected by a user present at the authorized computer system. When a computer system is not in use for an extended period of time, the operating system may enter a sleep state to conserve power. In the absence of a user during such periods, the computer device is vulnerable to attack.

In some embodiments, the computer device can be a client device and the computer system can be a web server, and vice versa. In at least one embodiment, a web server and a client device may each store protected electronic data. When a client device communicates with a web server, the client device may be interested in ensuring that the web server remains the authentic web server. Similarly, the web server may be interested in ensuring that the client device remains the authentic client device. Generally, the client device and web server are each interested in ensuring that they are communicating with the authentic web server and the authentic client device, respectively. In at least one embodiment, a computer component sends and receives information to other computer components via a communication port. This communication port may be, for example, a physical port (e.g. a USB port) or a software-defined port (e.g. a network socket).

When a computer component is described herein, it will be readily apparent that the computer component may be or include, for example, a computer device, a mobile device, or a web server. Furthermore, where a “host system” is described herein, it will be readily apparent that a host system includes the operating system of the host system.

Generally, in an exemplary embodiment of the invention, the computer component, to which access is being granted (the “target device”), may act as the stakeholder. The target device, acting as stakeholder, can verify that a second computer component, for which access is being sought (the “host system”), is the authentic host system. In some embodiments of the invention, the computer component and the second computer component may be simultaneously seeking access to each other, with each component playing both the roles of target device and host device, and each component acting as a stakeholder to ensure that the other is authentic.

A target device may be vulnerable to attacks that exploit any authentication scheme where authenticating a connecting device only occurs sparingly (e.g. once, at the start of the session). An operating system of a computer system may enter a number of different states for different purposes, such as the sleep state noted above. The security of data stored on a target device, for example, may be compromised when the operating system enters a “screen lock” state. In the “screen lock” state, power continues to be supplied to the target device and the target device remains unlocked. While the target device is unlocked, data on the target device may be vulnerable to theft, or “attack”. The “screen lock” state may thus require target device owners to be physically present to guard target devices from attacks.

One skilled in the art will also recognize that data stored on a target device may be compromised by a reboot or restart of the operating system of the computer system. During a reboot of the operating system, power may continue to be supplied to the unlocked target device. In at least one embodiment, during a reboot of the operating system, the target device may lock upon restart of the operating system and require pre-boot authorization, or authentication with a real PIN. This configuration may be advantageous over Trusted Peripheral (TPER) resets because TPER resets rely on the BIOS and operating system, which are more complex.

One skilled in the art will recognize that methods wherein the host system is the stakeholder may be vulnerable to attacks exploiting power cycles of the target device. For example, a host system may first gain access to the target device. Power to the target device may be removed and then an imposter may stand in the place of the authentic host system. Power to the target device may be restored and the imposter may access the target device using the access previously established by the authentic host system. Thus, when the authentic host system is removed or disconnected from the target device, the authentic host system cannot act as the stakeholder and protect the target device.

In some embodiments, to control access to a target device by a computer system, authorization of a host system to have access to the target device may be determined. A session can be started if the host system is authorized to have access to the target device. During the session, the host system may be provided access to the target device. During the session, the target device may monitor the computer system to determine if the session should be terminated. When the target device determines that the session should be terminated, access to the target device may be blocked.

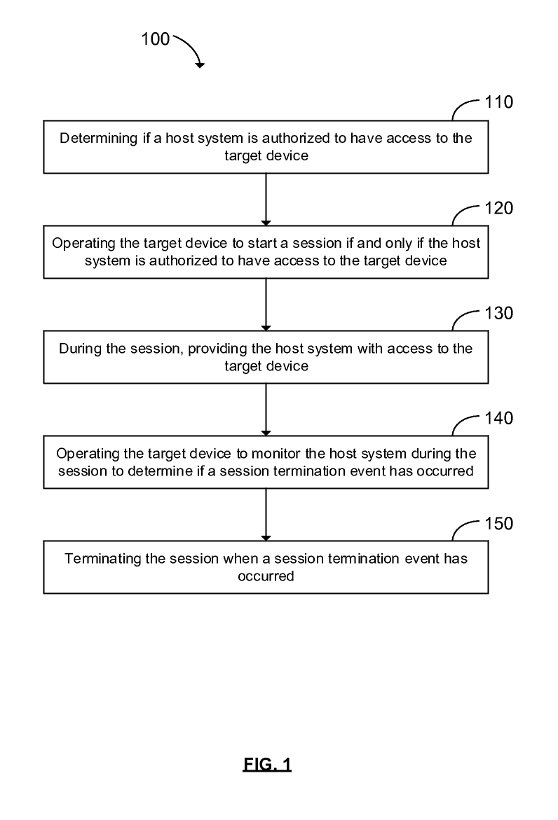

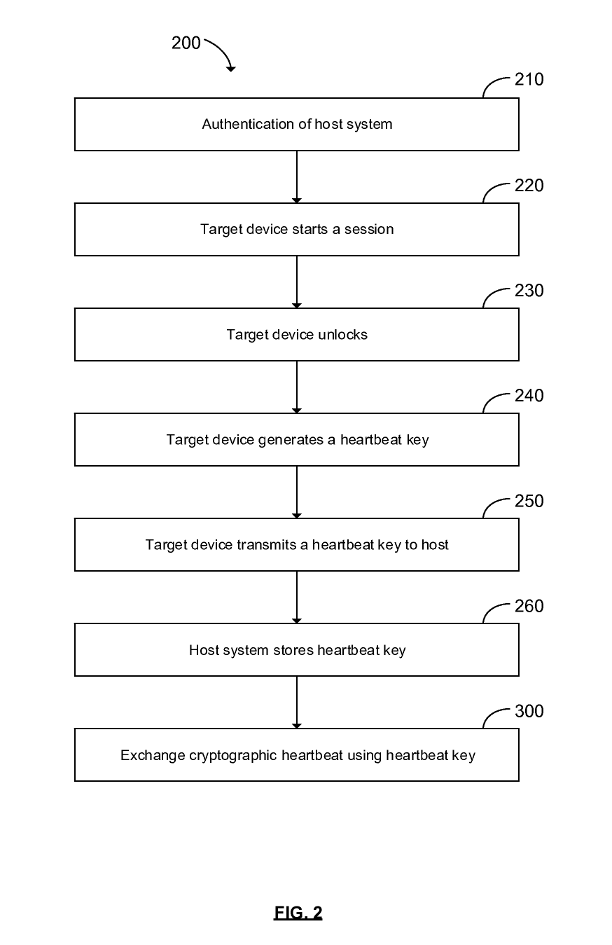

Reference is first made to FIG. 1, which illustrates a flowchart 100 of an example process of operating a target device to control access to a target device by a host system. At step 110, the target device may determine if host system is authorized to have access to the target device. For example, a user at the host system seeking to gain access to the target device may provide authentication. This authentication may be called a “real PIN”. A real PIN may correspond to an administrative PIN or a user PIN of Opal Storage Specifications.

At step 120, the target device may start a new session if and only if the host system is authorized to have access to the target device. Successful authentication may unlock the target device and begin a new session. In some embodiments, unlocking the target device may include disengaging other protective measures (e.g. unencrypting the contents of the target device). At step 130, during the session, access to the target device may be provided to the host system.

At step 140, the target device may be operated to monitor the host system during the session to determine if a session termination event has occurred. In at least one embodiment, the target device may monitor the host system during the session to determine whether the host system remains the authentic host system. That is, the target device may find that a session termination event has occurred when it encounters a host system that is not the authentic host system from which authentication was provided in step 110. In one at least embodiment, the target device monitors the host system by exchanging a cryptographic heartbeat between the target device and host system.

In some embodiments, the data sent to and from the target device during a session—data that is not itself involved in monitoring the host system through, e.g. a heartbeat exchange—may not itself be encrypted, regardless of whether the data involved in the monitoring of the host system (e.g. through a cryptographic heartbeat exchange) is encrypted. The skilled person will recognize that this may be useful and appropriate when, e.g., the probability that the data will be intercepted is low, or the data is not sensitive (but the authenticity of the host system is nevertheless important to the target device). In other embodiments, of course, most of the data sent to and from the target device, including data that is not exchanged as part of the monitoring of the host system, can be encrypted.

At step 150, the session may be terminated when a session termination event has occurred. When the session is terminated, the target device can be locked, preventing access to the target device. In some embodiments, locking the target device may include engaging other protective measures (e.g. encrypting the contents of the target device).

One way that the target device may monitor the operating system is by monitoring a heartbeat from the host system. When the target device monitors the host system using a cryptographic heartbeat between the target device and host system, the cryptographic heartbeat may be encrypted using a heartbeat key. The heartbeat key must be established before it can be exchanged. In some embodiments, the exchange of the heartbeat key is performed using any commonly-known method for enabling two parties with no prior knowledge of each other to jointly establish a shared secret over an insecure channel (e.g. the Diffie-Hellman key exchange).

The heartbeat key may be established upon authorization of the host system. After the heartbeat key is exchanged, the heartbeat key may not be communicated again between the target device and authentic host system. This can reduce the risk of the heartbeat key being intercepted by imposters.

In at least one embodiment, the heartbeat key may be formed of 256 bits. In at least one embodiment, the heartbeat key may be formed of 64 bits. In at least one embodiment, the heartbeat key may be formed of 128 bits. In at least one embodiment, the heartbeat key may be formed of 512 bits. The heartbeat key may be any appropriate size.

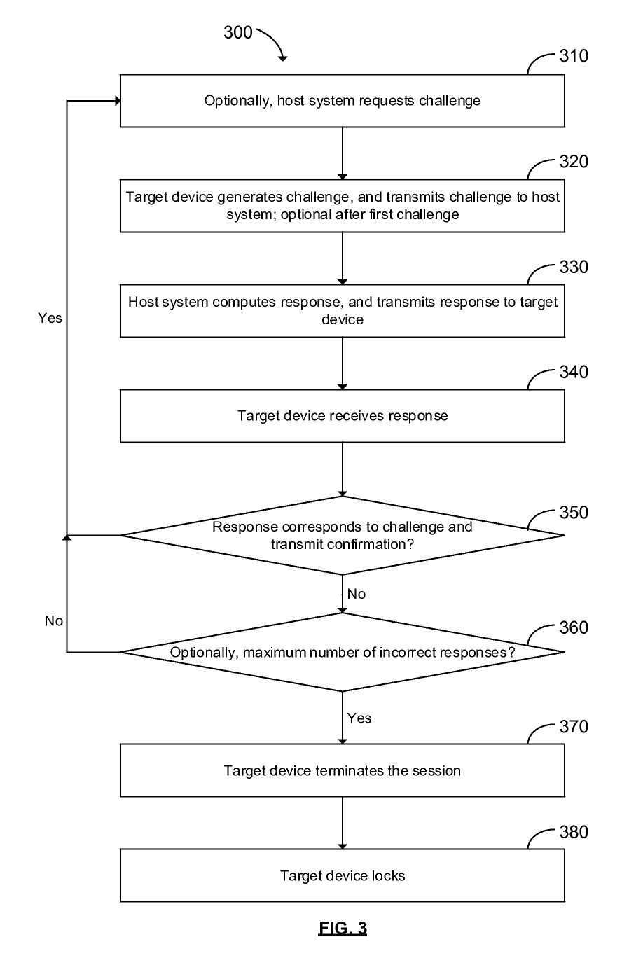

Reference is made to FIG. 2, which illustrates a flowchart 200 of an example process of establishing a heartbeat key.

At step 210, authentication of the host system is provided. Authentication of the host system may be provided by a user logging into a computer system operating a host operating system. At step 220, the target device may start a session after authentication is provided. At step 230, the target device may unlock itself. As mentioned previously, in some embodiments, unlocking the target device may include disengaging other protective measures (e.g. unencrypting the contents of the target device).

At step 240, the target device may generate a heartbeat key. The target device may be considered the stakeholder. As the stakeholder, the target device may generate the heartbeat key.

At step 250, the target device may transmit the heartbeat key to the host system. At step 260, the host system may store the heartbeat key. In some embodiments, the heartbeat key may be transmitted securely using commonly known methods for establishing a shared secret between two parties with no prior knowledge of each other over an insecure channel (e.g. a Diffie-Hellman key exchange). In embodiments of the invention where the two computer components are simultaneously monitoring each other for authenticity, they may each use the same heartbeat key for that purpose, and/or the respective transmissions of heartbeat keys between the two computer components (for the purposes of step 250) may occur contemporaneously.

Having established the heartbeat key, at step 300, the cryptographic heartbeat may be exchanged using the heartbeat key.

In at least one embodiment, the host system may automatically generate and provide the heartbeat key to the target device after the initial authentication. That is, the target device may expect to receive the heartbeat key after it is unlocked by a real PIN.

In at least one embodiment, the target device may require the host system to request a heartbeat key before generating a heartbeat key at step 240. This request may provide a command (e.g., “Get HEARTBEAT_KEY”). When the target device receives this request, it may then proceed to step 240 and provide a command to return the heartbeat key (e.g., “HEARTBEAT_KEY(HK)”).

In at least one embodiment where the host system is a computer system, the host system's operating system kernel (e.g., computer memory) may not be immediately available to store the heartbeat. The host system's operating system kernel may not be available if pre-boot operations are being performed and the BIOS or UEFI has not been restored. In this case, the pre-boot software of the host system may receive the heartbeat key from the target device. After the operating system boots, or loads, the host system may subsequently transfer the heartbeat key to the host system's operating system kernel when the kernel becomes available. The pre-boot software of the host system may be considered a first operating system instance, or a login operating system. The host system's operating system with kernel available may be a second operating system instance, or an authentic operating system. In one example, the authentication using a real PIN may be performed in a login operating system instance (e.g., SecureDoc Preboot Linux PBL) to enable access to the target device. Access to the target device may be continued for the authentic operating system (e.g., Windows) by recognizing it as the same session as the login operating system. Thus, the authentication of the first operating system instance is “handed off” to the second operating system instance. The session may be configured by a user upon initial authentication with a real PIN in a first operating system instance. Access to the target device in subsequent operating system instances may be governed by the configuration established in the first operating system instance.

In at least one embodiment, the target device may account for such a time delay for the host system's operating system kernel to be available for storing the heartbeat key. That is, the target device may wait some time before it transmits a heartbeat key to the host at step 250. One skilled in the art will recognize that if authorization is provided by a user logging into a system, waiting through such a time delay assumes the user will still be at the computer system at the end of the time delay. In at least one embodiment, the pre-boot process may require two minutes for completion.

Storage of the heartbeat key in the host system's operating system kernel may only require a change to the target device firmware or hardware. However, one skilled in the art may recognize that a heartbeat key stored on the host system's computer memory may be compromised. For example, the target device may be vulnerable to “cool RAM” attacks. A “cool RAM” attack can be, for instance, an attack when RAM is cooled immediately after power has been removed from the host system to preserve data for later retrieval.

Additional safeguards for the authentic host system may be provided to further protect the heartbeat key. The additional safeguards may be provided by various hardware implementations. In at least one embodiment, security of a heartbeat key stored on the host system may be enhanced by storing the heartbeat key in the processor of the host system (e.g., Intel® ME unit). One skilled in the art may recognize that the practice of storing the heartbeat key in such computer hardware may be less susceptible to cool RAM attacks.

Furthermore, once the heartbeat key is established (e.g., stored in the host system's computer hardware), the heartbeat key may not be exposed again. That is, the heartbeat key may not be transmitted between the host system and the target device after the initial authentication with the real PIN. As stated above, this can reduce the risk of the heartbeat key being intercepted by potential imposters.

Storage of the heartbeat key on the target device may be encrypted. That is, the heartbeat key may be inaccessible if the target device is locked, or powered off. Otherwise, the attacker may be able to read the heartbeat key when the target device is powered off. Having the heartbeat key, an imposter may restore power to the target device, continue exchanging cryptographic heartbeats, and thus continue the session and access the target device.

The heartbeat key can be encrypted on the target device using a “device key”. When the target device is unlocked, the device key may be used to decrypt the heartbeat key. When the target device is a “self-encrypting device” (SED), the device key can be an SED key that can be used to decrypt data stored on the SED. The data stored on the SED may be several gigabytes of data.

In at least one embodiment, the heartbeat key may be generated by the host system and transmitted to the target device. In at least one embodiment, the host system may require the target device to request a heartbeat key before generating a heartbeat key.

The cryptographic heartbeat may be exchanged after the heartbeat key is exchanged. In at least one embodiment, the cryptographic heartbeat exchange may include a challenge, which may be transmitted from the target device to the host system, and a response, which may be transmitted from the host system to the target device. In at least one embodiment, the cryptographic heartbeat exchange may further include a request for a challenge, which may be transmitted from the host system to the target device before the challenge. In at least one embodiment, the cryptographic heartbeat exchange may further include a confirmation of a response, which may be transmitted from the target device to the host system after the target device has received the response. In at least one embodiment, the cryptographic heartbeat exchange may not include a challenge. That is, the cryptographic heartbeat may be simply transmitted from the host system to the target device. Each or a combination of the request for a challenge, the challenge, the response, and the confirmation may be encrypted with the heartbeat key.

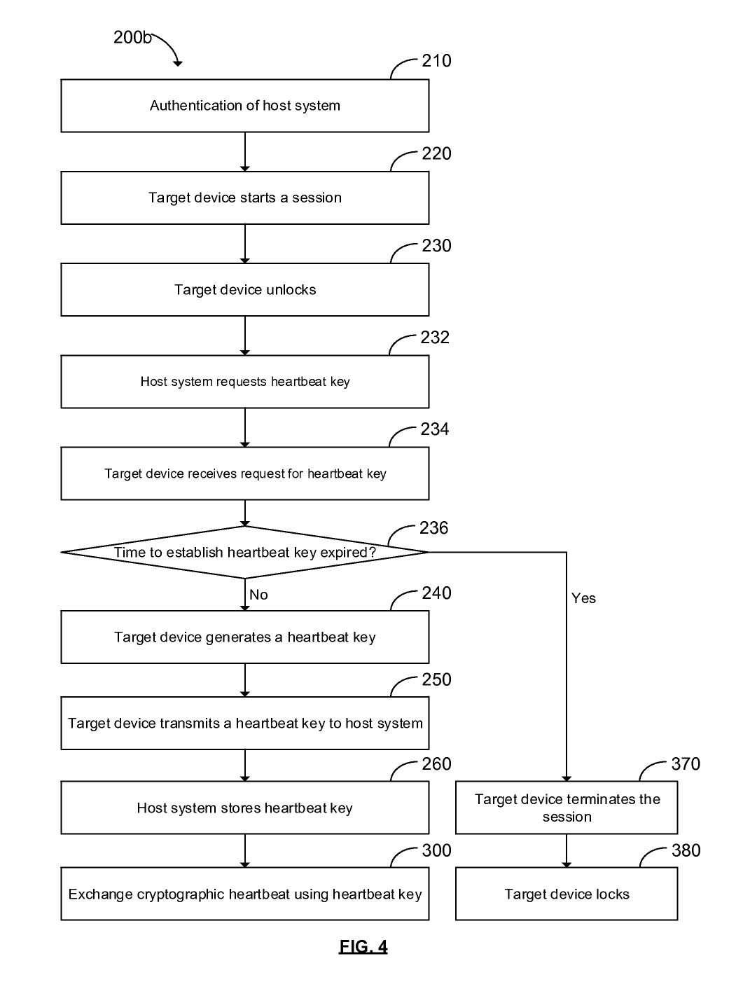

Reference is made to FIG. 3, which illustrates a flowchart 300 of an example process of exchanging cryptographic heartbeats.

The cryptographic heartbeat may be initiated by the host system at step 310. The host system may request a first challenge after receiving and storing the heartbeat key at step 260. When the cryptographic heartbeat is initiated by the host system at step 310, the host system (e.g., Windows kernel software) may periodically transmit a request to the target device. This request may provide a command (e.g., “Get HEARTBEAT”).

In response to receiving a request for a challenge from the host system, the target device may generate a challenge and transmit the challenge to the host system at step 320. The challenge may include a randomly generated number. The challenge may include a pre-determined number. The challenge may be encrypted using the heartbeat key. In at least one embodiment, the challenge may be formed of 16 bytes. In another embodiment, the challenge may be formed of 32 bytes. The challenge may be of any appropriate size. In at least one embodiment, the size of the challenge may be time varying. That is, a first challenge may be formed of 16 bytes. The next consecutive challenge may be formed of 32 bytes.

In at least one embodiment, the cryptographic heartbeat may be initiated by the target device at step 320 without step 310. The target device may periodically transmit a challenge to the host system. When the cryptographic heartbeat is initiated by the target device, the message load can be reduced. For example, when the cryptographic heartbeat is initiated by the host system with a request, a total of four messages between the host system and target device may be transmitted including a request, challenge, response, and confirmation. However, when the exchange is initiated by the target device, a total of three messages between the host system and target device may be transmitted including a challenge, response, and confirmation.

In at least one embodiment, the communication between the host and target device may comply with additional requirements. For example, OPAL protocol may require messages to be transmitted in pairs (e.g., a “Trusted Send” message followed by a “Trusted Receive” message). Furthermore, OPAL protocol may further require communications to be initiated by the host system. That is, a “Trusted Send” may first be transmitted from the host system to the target device followed by a “Trusted Receive” from the target device to the host system.

In at least one embodiment, the cryptographic heartbeat may be initially initiated by the host system at step 310, where a first challenge request is sent to the target device. In response to the first challenge request, the target device at step 320 may periodically transmit a challenge to the host system without additional requests for challenges.

In at least one embodiment, the cryptographic heartbeat may be initiated—whether by the target device or the host system—at a predetermined frequency. In at least one embodiment, the cryptographic heartbeat may be initiated every second. In at least one embodiment, the cryptographic heartbeat may be initiated at a variable frequency. In at least one embodiment, the cryptographic heartbeat may be initiated if a long interval has elapsed since the host system and target device last communicated (but a session termination event has not yet occurred). This scheme may be useful in those embodiments where sessions are meant to last for indefinite periods of time (e.g. when the target device and host system persistently remain in communication with one another), or in those embodiments where the cryptographic heartbeat is initiated at a rate commensurate with the flow of data between the host system and target device (e.g. every 512 kilobytes sent and/or received). A default period of time, of, say, a couple of hours can be initially pre-defined, but, for example, administrators of the target device may, in some embodiments, be authorized redefine this default period of time depending on relevant considerations. For example, such relevant considerations could include i) increasing the default period of time in response to prior premature termination of sessions due to the default time interval having elapsed without communication between the host system and the target device; or ii) decreasing of the default period of time in response to the information being exchanged being of heightened sensitivity or highly confidential, or due to an increased threat level or probability of attack. In at least one embodiment, wherein the target device initiates the cryptographic heartbeat, the target device may initiate the cryptographic heartbeat ahead of schedule if it observes a suspicious event, such as after a sleep state. The sleep state will be discussed in greater detail below.

At step 330, the host system may receive the challenge. Upon receipt of the challenge, the host system may decrypt the challenge. At step 330, the host system may transmit, to the target device, a response that corresponds to the challenge. The term “corresponds” refers to a response that is correct. Each challenge has a correct response that “corresponds” to that challenge. In at least one embodiment, the challenge response may be the decrypted challenge. In at least one embodiment, the host system may perform an operation using the decrypted challenge in order to generate a response. When each response is generated based on the last response, the message load after the initial exchange can be further reduced to two messages including a response and confirmation. In some embodiments, response instructions generated by the target device concerning the scheme of the cryptographic heartbeat exchange may be provided with the first challenge transmitted by the target device. That is, the first challenge transmitted by the target device can indicate the type of cryptographic heartbeat that may be exchanged—whether a challenge may be issued for each heartbeat, for example, and what sort of response or responses the target device is expecting. Generally, the response instructions would include the information necessary for the host system to generate the sort of response or responses that the target device is expecting. In some embodiments, there may be only one challenge sent by the target device for the duration of a session. In some embodiments in which only one challenge is sent by the target device during the session, this challenge may comprise only the response instructions. Once in possession of those response instructions, the host system may transmit the cryptographic heartbeat as required by the scheme defined by the response instructions. In at least one embodiment, the response may be encrypted using the heartbeat key.

In at least one embodiment, the cryptographic heartbeat may be initiated by the host system at step 330 without step 310 and step 320. That is, the host system may periodically transmit a response to the target device. When the cryptographic heartbeat is transmitted by the host system without a request for a challenge and without a challenge, and the response instructions for the cryptographic heartbeat exchange are established at some prior time (e.g. with the exchange of the heartbeat key, or by hardcoding or manual configuration), the message load can be reduced. In at least one embodiment, the host system may generate a response by performing an operation using the last response. That is, each response may be based on the previous response. In some embodiments, generating a response may also involve performing an operation on the last response and/or a number or set of numbers received with the response instructions. For example, a host system may generate and send to the target device a series of responses where each response is an increment of the previous one and the first response may correspond to the number received with the response instructions.

In at least one embodiment, the response instructions may instruct the host system to count the number of transactions that have transpired during the session, or some subset thereof. In some embodiments, such as ones where the target device is a data storage device, this count reflects the number of read/write transactions requested by the host system. In some embodiments, the count reflects the number of transactions that have transpired since the last heartbeat exchange. The response instructions may also instruct the host to maintain, as a transaction count vector, multiple counts of transactions that transpire during the session between the host system and target device. In some embodiments, the response instructions may further instruct the host system to generate, for each heartbeat, a host system transaction count (from the host system's current transaction count or transaction count vector), and to send to the target device a response that contains the host system transaction count or some value or values derived from it. In some embodiments, the host system transaction count is derived from one or more statistical metrics, such as the length of time between transactions, the distribution of the length of time between transactions, and/or the distribution of transactions themselves or different kinds of transactions.

In at least one embodiment, the response may be formed of 16 bytes. In at least one embodiment, the response may be formed of 32 bytes. The response may be formed of any other appropriate size. In at least one embodiment, the size of the response may be time varying. That is, a first response may be formed of 16 bytes. The next consecutive response may be formed of 32 bytes.

At step 340, the target device may receive the response. If the response is encrypted using the heartbeat key, the target device may decrypt the challenge.

At step 350, the target device may verify that the response is correct, or corresponds to the challenge sent at step 320. That is, the target device may determine whether the content of the response is correct. When the host system generates a response by performing an operation on the last response or the decrypted challenge, the target device must know, in advance, the operation and the expected outcome of the operation, or what response will be derived based, at least in part, on the last or immediately prior response. In such embodiments, the target device can analyze the response to see if it corresponds to the expected outcome of the operation.

In some embodiments, the target device may maintain a target device transaction count, which reflects the number of transactions that have transpired during the session between the host system and target device or some subset thereof. In some embodiments, the target device may be maintaining multiple transaction counts as a vector, The target device may check each response for whether that response's host system transaction count (or its value or values derived from the host system transaction count) matches the target device transaction count or vector (or corresponding value or values derived from target device transaction count or vector), or is within an acceptable threshold. In such embodiments, it can be important that the host system and target device determine their respective transaction counts using commensurable approaches, and the response instructions provided to the host system can be augmented to include instructions on how the host system is to determine its transaction count.

If a correct response is received, the target device may optionally transmit a confirmation to the host system to indicate that the response was received and verified to be correct. After the host system receives the confirmation that the response was correct, the heartbeat exchange may re-iterate, returning to step 310, or step 320. In embodiments where the host system does not receive confirmation for correct responses, the heartbeat exchange can return to step 330 and the target device can await further responses. In at least one embodiment, the confirmation to the host system may indicate that the response was incorrect. If host system does not receive a confirmation that the response was correct or if the host system receives a confirmation that indicates that the response was incorrect, the host system may resend the last response.

In at least one embodiment, the target device may accept a pre-determined number of incorrect responses before terminating the session. Incorrect responses may include responses that do not correspond with the most recently issued, or outstanding, challenge response. Where the host system generates a response by performing an operation on the last response or the decrypted challenge, incorrect responses may also include those that do not correspond to the expected outcome of the operation. At step 360, the target device may determine whether the maximum permitted number or threshold number of incorrect responses has been received. If the maximum number of incorrect responses has been received, the process may proceed to step 370, at which point the target device may terminate the session. In some embodiments, the transaction counts may include the calculation of certain statistical metrics, such as the length of time between transactions, the distribution of the length of time between transactions, the distribution of transactions themselves or different kinds of transactions, and/or values derived from these distributions. If a certain statistical metrics deviates from a corresponding acceptable range, the process may proceed to step 370, at which point the target device may terminate the session. The acceptable range or ranges may be configurable at the target device. The acceptable range or ranges may be selected to maximize the likelihood of detecting an attack and/or to minimize the likelihood of a false positive detection of an attack.

In at least one embodiment, the maximum number of incorrect responses may be one. That is, the session may be terminated after one incorrect response. In at least one embodiment, the maximum number of incorrect responses may be greater than one. The maximum number of incorrect responses may be any appropriate positive integer selected based on factors including the likelihood that an incorrect response will be generated, and the risk of attack (where the risk of attack is a function of both the probability of attack and the expected negative consequences of attack).

At step 360, the target device may determine that the number of incorrect responses received has not yet exceeded the threshold number or the maximum number of incorrect response. If the maximum number of incorrect responses has not been received, the target device may permit the session to continue and the cryptographic heartbeat may re-iterate, returning to step 310, or step 320. In embodiments where the host system does not receive confirmation for correct responses, the heartbeat exchange can return to step 330 and the target device can await further responses.

After the target device terminates the session at step 370, the target device may lock itself at step 380. As mentioned previously, in some embodiments, locking the target device may include engaging other protective measures (e.g. encrypting the contents of the target device). The target device may also erase the heartbeat key from the target device. As well, the host system may erase the heartbeat key from the host system's operating system kernel. In at least one embodiment, clearing or erasing the heartbeat key from the host system's operating system kernel may be performed by the BIOS upon reboot or restart of the operating system of the computer system. Generally, starting a new operating system or stopping the current operating system on the host system can only be performed by a system reboot. When the heartbeat key is erased by the BIOS, sessions can be terminated upon reboot of the host system. This proactively terminates sessions even before the target device monitoring detects that a session termination event has occurred, or without the target device monitoring determining that a session termination event has occurred. In at least one embodiment, monitoring a cryptographic heartbeat includes considering the content of the cryptographic heartbeat as well as the timing of the cryptographic heartbeat.

One skilled in the art may recognize that data may be compromised between consecutive cryptographic heartbeats before the session is terminated. In at least one embodiment, the timing of the cryptographic heartbeat may be configured so that the amount of data that may be obtained between consecutive cryptographic heartbeats before the session is terminated would be so small as to be useless.

In at least one embodiment, a host system may have limited time to establish the heartbeat key after the host system is authenticated using a real PIN.

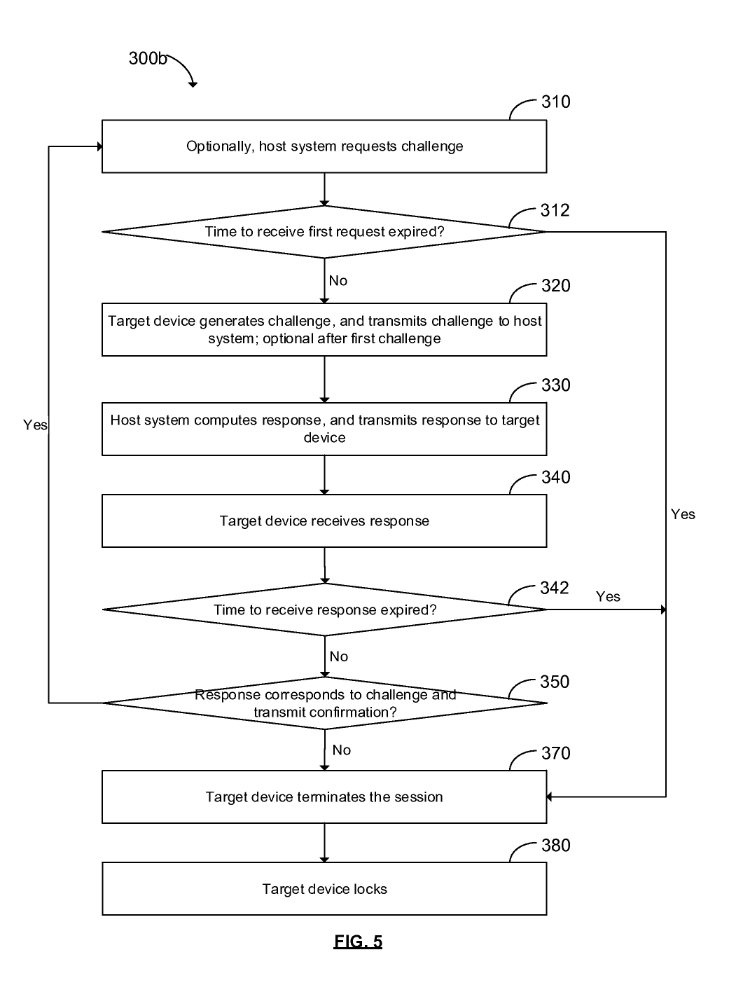

Reference is made to FIG. 4, which illustrates a flowchart 200b of an example process of establishing a heartbeat key with a time limit. Various steps of process 200b are similar to steps of process 200. Similar steps are identified by similar reference numerals and are not described again.

As described above, the target device may require the host system to request a heartbeat key before generating a heartbeat key at step 240. This is shown at step 232 and step 234. At step 232, the host system may request a heartbeat key. At step 234, the target device may receive the request for a heartbeat key.

The target device may require the host system to request the heartbeat key within a time limit (e.g., HEARTBEAT_KEY_TIME) from the time of authentication, or login. The time limit to establish the heartbeat key may be any appropriate time duration. In at least one embodiment, the time limit to establish the heartbeat key may be pre-determined. In at least one embodiment, the time limit to establish the heartbeat key may be configurable.

The time limit to establish the heartbeat key may account for the time needed for the host system's operating system kernel to be available for storing the heartbeat key. That is, the time limit to establish the heartbeat key may be long enough to permit the pre-boot process to complete or resume after hibernation. By accounting for the pre-boot process, the heartbeat operations may be performed by the Windows kernel software instead of the pre-boot software. The reboot process may require two minutes. In at least one embodiment, the time limit to establish the heartbeat key may be two minutes from the time of authentication using a real PIN.

If the pre-boot process is not accounted for, the target device may terminate the session, lock itself, and a blue screen of death may occur. As mentioned previously, in some embodiments, locking the target device may include engaging other protective measures (e.g. encrypting the contents of the target device).

At step 236, the target device may determine whether the time to establish the heartbeat key has expired or elapsed. If the time to establish the heartbeat key has not expired, the session may continue to step 240 and the target device may generate a heartbeat key. If the time to establish the heartbeat key has expired, the process may proceed to step 370 and the target device may terminate the session. After the target device terminates the session at step 370, the target device may lock itself at step 380. The target device may also erase the heartbeat key.

In at least one embodiment, a host system may have limited time to initiate the heartbeat after the heartbeat key established.

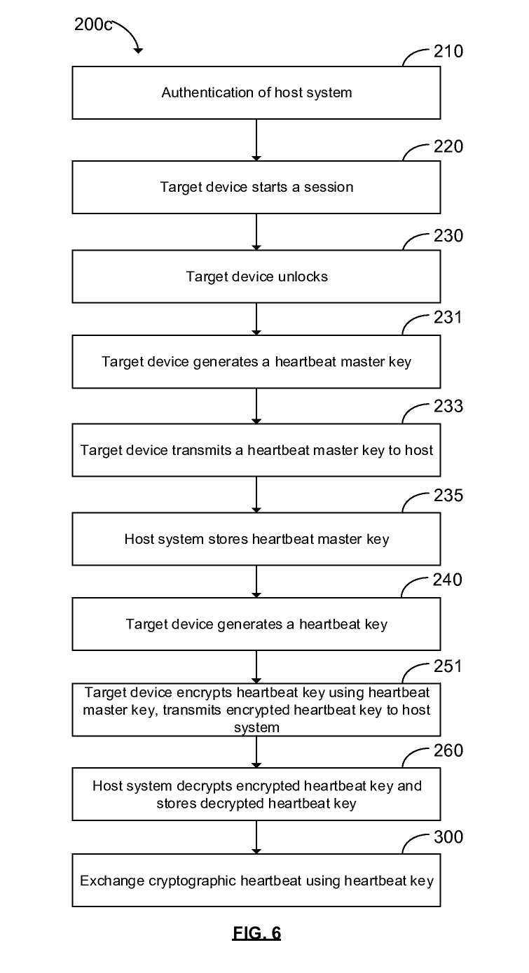

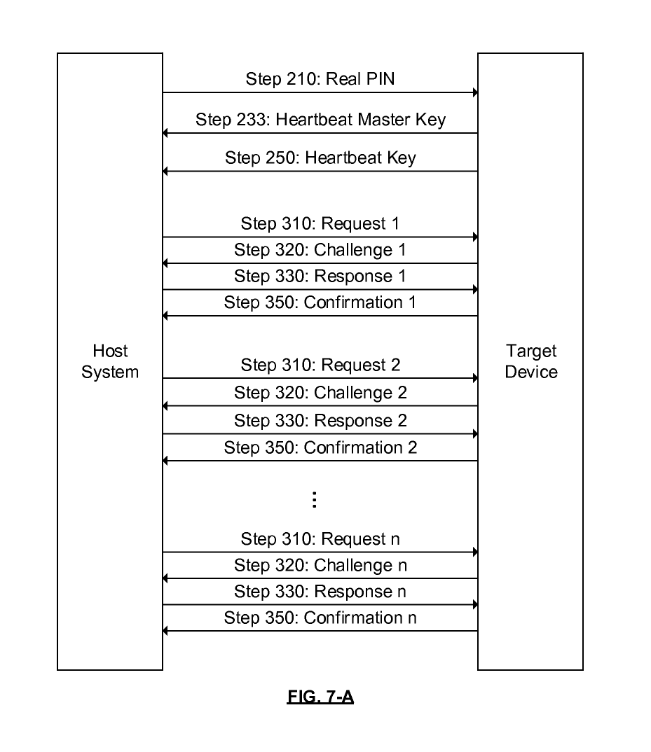

Reference is made to FIG. 5, which illustrates a flowchart 300b of an example process of exchanging heartbeats with time limits. Various steps of process 300b are similar to steps of process 300. Similar steps are identified by similar reference numerals and are not described again.

As described above, a cryptographic heartbeat may be initiated by the host system at step 310. The target device may require the host system to initiate the cryptographic heartbeat by requesting the first challenge after receiving the heartbeat key within a time limit (e.g., HEARTBEAT_FIRST_TIME). The time limit to request the first challenge may be any appropriate time duration. In at least one embodiment, the time limit to request the first challenge may be pre-determined. In at least one embodiment, the time limit to request the first challenge may be configurable.

The time limit to request the first challenge may depend on whether the heartbeat key is established during pre-boot or after pre-boot. The time limit to request the first challenge may be flexible. In at least one embodiment, the heartbeat key may be established during pre-boot and the time limit to request the first challenge may be the same as the time limit for establishing the heartbeat key during pre-boot (e.g., HEARTBEAT_KEY_TIME). In at least one embodiment, the time limit to establish the heartbeat may be two minutes from the time that the heartbeat key is established.

In at least one embodiment, the heartbeat key may be established after pre-boot and stored in the host system's operating system kernel. When the heartbeat key is established after pre-boot, the host system can request a challenge immediately and the target device may use a shorter time limit.

In at least one embodiment, the time limit to establish the heartbeat may be two seconds from the time that the heartbeat key is established.

At step 312, the target device may determine whether the time to request the first challenge has expired or elapsed. If the time to request the first challenge has not expired, the session may continue to step 320 and the target device may generate a challenge. If the time to request the first challenge has expired, the process may proceed to step 370 and the target device may terminate the session.

As described above, the target device may receive the response at step 340. The target device may require the host system to provide a response within a time limit (e.g., HEARTBEAT_TIME). In at least one embodiment, the time to receive a response may be relative to the time that the challenge is transmitted (step 320). In at least one embodiment, the time to receive a response may be relative to the time that the previous response is received (previous step 340).

The time limit to receive the response may be any appropriate time duration. In at least one embodiment, the time limit to receive the response may be pre-determined. In at least one embodiment, the time limit between consecutive heartbeats may be configurable. In at least one embodiment, the time limit to receive a response may be two seconds from the time that the last response is received.

The time to receive a response (e.g., HEARTBEAT_TIME) can generally be less than the time to establish the heartbeat key (e.g., HEARTBEAT_KEY_TIME). As noted above, when the heartbeat key is established after pre-boot, the time to request the first challenge may use a shorter time limit. In at least one embodiment, the heartbeat key may be established after pre-boot and the time limit for requesting the first challenge may be the same as the time limit for receiving a response.

Returning to FIG. 5, at step 342, the target device may determine whether the time to receive the response has expired or elapsed. If the time to receive a response has not expired, the session may continue to step 350 and the target device may determine whether the response corresponds to the challenge. In at least one embodiment, if the time to receive a response has not expired and the target device has not received a response, the target device may generate and transmit another challenge. If the time to receive a response has expired, the process may proceed to step 370 and the target device may terminate the session. In some embodiments, the target device may also vary the time to receive a response based on the distribution of the lengths of time between receiving heartbeats.

Whether the target device terminates the session due to expiration of the time to receive a first request at step 312, expiration of the time to receive a response at step 342, or the response not corresponding to the challenge at step 350, the target device may lock itself at step 380. The target device may also erase the heartbeat key.

In at least one embodiment, a user may configure the cryptographic heartbeat exchange, which may include time limitations for various steps. In at least one embodiment, a user may configure a limit for the time that may elapse from the time of authentication to the time of a request for a heartbeat key (e.g., HEARTBEAT_KEY_TIME). In at least one embodiment, a user may configure a limit for the time that may elapse from the time of a request for a heartbeat key to the time of a request for a first challenge. In at least one embodiment, the user may configure a limit for the time that may elapse from the time of a first heartbeat request to the time of a second heartbeat. Each user configurations may be provided by a command (e.g., “Set HEARTBEAT_KEY_TIME”, “Set HEARTBEAT_FIRST_TIME”, or “Set HEARTBEAT_TIME”).

The method disclosed herein may abate hot-swap cable attacks. In the event that a hot-swap data cable attack occurs, an imposter host system will not have the heartbeat key. A hot-swap data cable attack may occur after step 260. When the imposter host system receives an encrypted challenge from the target device at step 330, the imposter host system cannot decrypt the challenge and provide a response to the challenge at step 340. When the time limit for the target device to receive a response expires at step 342, the target device terminates the session step 370 and locks itself at step 380. The target device may also erase the heartbeat key.

Even if an imposter host system provides a fraudulent response within the time limit for receiving a response, the response may not correspond to the challenge at step 350. As described above, the response may be formed of 32 bytes. The larger the size of the response, the lower the likelihood that a fraudulent response being correct.

In the event that an attacker reboots the computer system, such as to Linux or an operating system on an external data storage device (e.g., USB), the imposter host system would typically not have the heartbeat key. Similar to a host-swap data cable attack, without the heartbeat key, the imposter host system cannot decrypt the challenge and provide a response to the challenge at step 340. Again, when the time limit for the target device to receive a response expires at step 342, the target device terminates the session step 370 and locks itself at step 380. The target device may also erase the heartbeat key.

The target device generates and transmits the heartbeat key after pre-boot authorization (e.g., authentication with a real PIN). When the target device is re-booted, it can remain unlocked. However, the target device cannot generate and transmit a heartbeat key without pre-boot authorization. Thus, the target device cannot generate and transmit a heartbeat key following a re-boot. An imposter host system who stands in the place of an authentic host system following a re-boot cannot have the heartbeat key. Similar to a host-swap data cable attack, the imposter host system cannot decrypt the challenge and provide a response that corresponds to the challenge at step 340.

In at least one embodiment, the host system may perform setup operations to the target device after authentication. In at least one embodiment, a user may authenticate using an administrative PIN and then disable the cryptographic heartbeat. That is, the administrative PIN may be used to indicate to the target device that monitoring the host system is not required. It may be appropriate to disable the cryptographic heartbeat when maintenance is being performed on the target device, such as data recovery.

In at least one embodiment, the cryptographic heartbeat may be disabled for the remainder of the current data storage power cycle. That is, the target device may resume the requirement for a cryptographic heartbeat if power to the target device is removed and restored. This setup operation may be provided by a command (e.g., “Skip HEARTBEAT_KEY”).

For security purposes, additional features of the target device may be configured using the administrative mode. If for whatever reason an error occurs, for example, when the operating system encounters a system error (e.g., crashes), the administrative PIN may be used to start a new session.

In at least one embodiment, the cryptographic heartbeat may be disabled until the cryptographic heartbeat is re-enabled by a subsequent setup operation. That is, the target device may not require a cryptographic heartbeat even after power to the target device is removed and restored. This setup operation may be provided by a command (e.g., “Disable HEARTBEAT_KEY”). The subsequent setup operation to re-enable the cryptographic heartbeat after the cryptographic heartbeat has been disabled may be provided a command (e.g., “Enable HEARTBEAT_KEY”).

In at least one embodiment, the time limit within which the target device requires the host system to provide a response (e.g., HEARTBEAT_TIME) may be disabled. That is, the target device may not require a cryptographic heartbeat. In at least one embodiment, this configuration may be established by a command. In at least one embodiment, this configuration may be established by the host system or the target device. For example, the target device and the host system may each determine that it is unnecessary to exchange heartbeats when the host system is in the process of, or continuously accessing data on the target device. In at least one embodiment, upon determining that it is unnecessary to exchange heartbeats, the target device may not transmit a challenge to the host system after a request is received from the host system. In at least one embodiment, upon determining that it is unnecessary to exchange heartbeats, the host system may delay transmission of the response to the target device until it is no longer accessing data on the target device. In at least one embodiment, the host system may postpone transmission of the response to the target device until the host system requires access to the target device. In at least one embodiment, the host system may determine that the time duration since a last transmitted response has exceeded a time limit and the host system may transmit the response before it requires access to the target device.

The message load and processing demand on the host system and the target device and may be reduced when the time limit within which the target device requires the host system to provide a response (e.g., HEARTBEAT_TIME) is disabled. A reduction in processing demand may minimize the impact of implementing the cryptographic heartbeat, which may in turn, increase the acceptance of the cryptographic heartbeat.

During the sleep state, power may not be supplied to the target device and the target device may be locked. The target device cannot be unlocked using a real PIN because the host system (referring here to the operating system) is not running with full functionality. That is, the host system cannot access the target device. Furthermore, unlocking the target device cannot be performed by the BIOS because BIOS operations are only performed on reboot. Traditionally, to unlock the target device after the sleep state, kernel software caches the real PIN used to authenticate and unlock the target device prior to entering the sleep state. Upon resuming the operating system after the sleep state, the kernel software provides the cached real PIN to unlock the target device.

In at least one embodiment, a special PIN may allow the target device to recognize the session before and after a sleep state as being the same session. That is, the host system and the target device may continue the cryptographic heartbeat. Thus, a session, wherein access to the target device is provided, may span over several sleep states.

When data stored on the target device cannot be read by an external entity without power to the drive, the heartbeat key and the special PIN may be stored on the target device. Generally, upon resuming power after the sleep state, the target device may use the heartbeat key to encrypt at least a part of the special PIN as at least part of the challenge. In return, the host system can decrypt the challenge and return the at least a part of the special PIN as at least part of the response to the challenge. When applicable, the target device may unlock the data storage drive.

In at least one embodiment, the cryptographic heartbeat and the “special PIN” may unlock the target device after a sleep state. When data stored on the target device can be read by an external entity without power to the drive, the heartbeat key can be stored so that it is inaccessible when the device is locked. However, upon resuming power after the sleep state, the target device cannot use the heartbeat key to encrypt the challenge. However, the target device can use an encrypted special PIN as at least a part of the challenge. In return, the host system can decrypt the challenge and return the special PIN as at least part of the response to the challenge.

When the target device receives the response from the host system, the target device may further process the special PIN. The target device may recognize the special PIN and know that it has just resumed from a sleep state and that it may be in an insecure mode for some period of time. The target device can use the decrypted special PIN to unlock itself.

After the target device unlocks itself, it can access the heartbeat key from the session prior to the sleep state. Having access to the heartbeat key from the session prior to the sleep state, the target device may generate, encrypt, and transmit a challenge to the host system as usual.

Real PINs, such as the administrative PIN or the user PIN, are not affected by special PINs presented herein. Special PINs are different from real PINs because they may only be used for the next time that power is restored to the target device. Traditionally, authentication with a real PIN is processed before the device key can be built and used to unlock the target device. Meanwhile, special PINs may be used autonomously, without the user's authentication or intervention, to unlock the target device. Thus, additional measures may be required to ensure that the special PIN is not exploited for attacks. Namely, that an attacker who can read all memory on the host system cannot unlock the target device. Furthermore, an attacker who can read the target device cannot unlock and decrypt it. Hence, an attack may require both the target device as well as the host system to access the data stored on the target device.

In at least one embodiment, the processing of the special PIN may be provided by encryption. In at least one embodiment, the encryption may an exclusive OR (XOR) function, a hash function, or any other appropriate cryptographic technique. One skilled in the art will recognize that additional data may be required to encrypt the special PIN using a hash function. The additional data is herein referred to as “second data”. Unlike the heartbeat key, the second data may be stored unencrypted and readable on the target device when it is locked. Furthermore, the second data may only be used once. Thus, combining the special PIN with the second data may result in the creation of a one-time derivative of the special PIN. Such a special PIN may have limited use for an attacker since it may only be used for one instance. When a special PIN is described herein, it will be readily apparent that it includes a one-time derivative of the special PIN.

Each of the special PIN and the second data may be formed of a random number. Each of the special PIN and the second data may be formed of 16 bytes, 32 bytes, or any other appropriate size. In at least one embodiment, the host system can process the special PIN as a usual response without recognizing that the challenge contains a special PIN.

Furthermore, the special PIN may be a “sleep PIN” or a “heartbeat PIN”, or another appropriate temporary PIN. The preceding description of the special PIN applies to each, a sleep PIN and a heartbeat PIN.

In at least one embodiment, the special PIN may be a sleep PIN used for a single instance of a sleep state. This sleep PIN may only be used once, for a resumption of power after that sleep state that it was issued for. The sleep PIN may be established immediately prior to entering sleep state and power to the target device being removed. After a sleep PIN is used, the target device may invalidate the used sleep PIN. In at least one embodiment, the host system may, at that time, also establish a new sleep PIN for the next sleep state.

In at least one embodiment, the special PIN may be a heartbeat PIN used for all instances of sleep states during a single session. This heartbeat PIN may be issued in one session and subsequently used and re-used to unlock the target device after sleep states of that session. In contrast to the sleep PIN, which is established immediately prior to entering sleep state, the heartbeat PIN may be established after initial authentication with a real PIN.

The target device may continue to use the heartbeat PIN for another instance of a sleep state. If the host system returns a response that does not correspond to the heartbeat PIN, then the target device cannot use the heartbeat PIN as a challenge again. Thus, the heartbeat PIN may be valid until a session terminates. Once a session terminates, the target device may invalidate the heartbeat PIN for that session.

Generally, sessions may be initiated when authentication is provided using a real PIN to unlock the target device. In at least one embodiment, use of the heartbeat PIN to unlock the target device does not start a new session.

As set out above, after a session terminates at step 370, the target device locks itself and erases the heartbeat key at step 380. In at least one embodiment, the target device may also erase the heartbeat PIN at step 380.

The sleep PIN can generally be less secure than the heartbeat PIN. However, the sleep PIN because may be implemented with systems having less hardware or software capabilities. The heartbeat PIN may be more secure than the sleep PIN because the heartbeat PIN is established at a time when the host system is more likely to be the authentic host system. Specifically, the heartbeat PIN can be established after the authentication using a real PIN instead of immediately before the sleep state. Since the sleep PIN can be established before each sleep state, the sleep PIN may be transmitted before each sleep state. An imposter host system may intercept the sleep PIN during transmission and subsequently stand in the place of the authentic host system after the sleep state.

Similar to the heartbeat key, a special PIN stored on the computer memory may be compromised. For example, the target device may be vulnerable to “cool RAM” attacks. That is, an attack when RAM is cooled immediately after power has been removed from the system in order to preserve and retrieve data.

Additional safeguards for the authentic host system may be provided to further protect the special PIN. The additional safeguards may be provided by various hardware implementations. In at least one embodiment, security of a special PIN stored on the host system may be enhanced by storing the special PIN in the host system's processor (e.g., Intel® ME unit), where the host system is a computer. One skilled in the art may recognize that storing the special PIN in computer hardware may be less susceptible to cool RAM attacks.

In at least one embodiment, the special PIN may be disabled if the host system is not expected to enter sleep states.

In contrast to a sleep state, resumption after a hibernation state requires a real PIN. Upon receipt of a real PIN, the target device may generate a new heartbeat key and start a new session. Thus, sessions before and after a hibernation state are considered two different sessions.

Optionally, a heartbeat master key may be used to further secure the setup, transmission, or establishment of the heartbeat key from the target device to the host system. Use of a heartbeat master key may reduce the exposure of the heartbeat key during transmission between the target device and the host system.

In at least one embodiment, the administrative PIN may be used to establish a heartbeat master key. That is, the host system may transmit the administrative PIN to the target device to indicate that a new heartbeat master key may be established. If manner, if the target device loses the heartbeat key, for whatever reason, during a session (e.g., after it has been established with the host system), the user may use the administrative PIN to start a new session. The heartbeat master key may be based on an advanced encryption standard. In some embodiments, the heartbeat master key and/or the administrative PIN may be securely transmitted using commonly known methods for establishing a shared secret between two parties with no prior knowledge of each other over an insecure channel (e.g. a Diffie-Hellman key exchange).

After the heartbeat master key is transmitted to the host system, it can be kept secret on the target device. That is, after transmitting the heartbeat master key to the host system, the target device does not transmit the heartbeat master key again. Furthermore, the heartbeat master key cannot be extracted from the target device. One skilled in the art will recognize that the heartbeat master key is stored on the host system and may be compromised from the host system side. However, because the heartbeat master key may be used only to secure the setup or establishment of the heartbeat key, the vulnerability of the heartbeat master key may not be a concern.

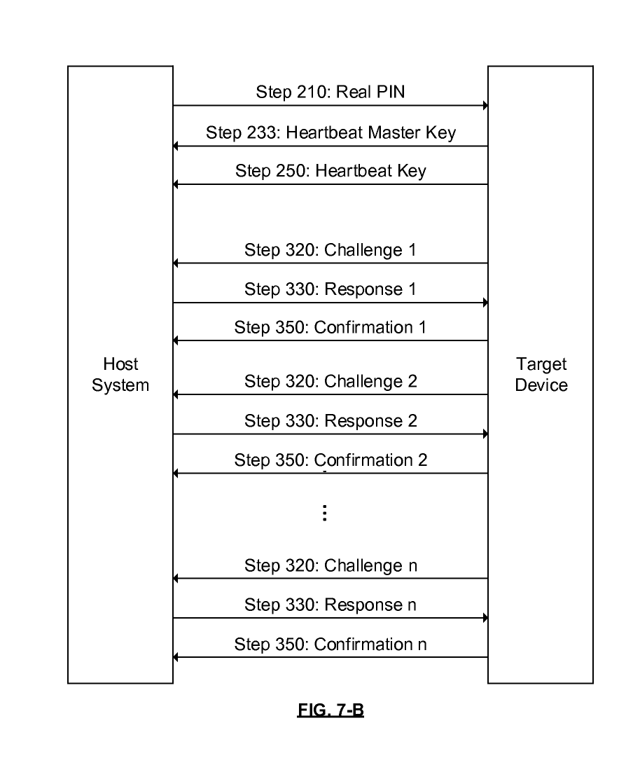

Reference is made to FIG. 6, which illustrates a flowchart 200c of an example process of establishing a heartbeat key with a heartbeat master key. Various steps of process 200c are similar to steps of process 200. Similar steps are identified by similar reference numerals and are not described again.

As described above, the data storage may unlock at step 230. At step 231, the target device may generate a heartbeat master key. At step 233, the target device may transmit the heartbeat master key to the host system. At step 235, the host system may store the heartbeat master key.

Having established the heartbeat master key, the target device may proceed with establishing the heartbeat key. At step 240, the target device may generate a heartbeat key. At step 251, the target device may encrypt the heartbeat key using the heartbeat master key and transmit the encrypted heartbeat key. At step 261, the host system may decrypt the encrypted heartbeat key and store the decrypted heartbeat key.

In at least one embodiment, the administrative PIN may be used to disable the heartbeat master key.

In at least one embodiment, actions between the target device and the host system may be logged. In at least one embodiment, the logs may subsequently be audited to detect suspicious behavior. Actions that may be logged include each or any combination of the transmission of real or temporary PINs, heartbeat master keys, heartbeat keys, response instructions, and cryptographic heartbeats including requests for challenges, challenges, and responses.

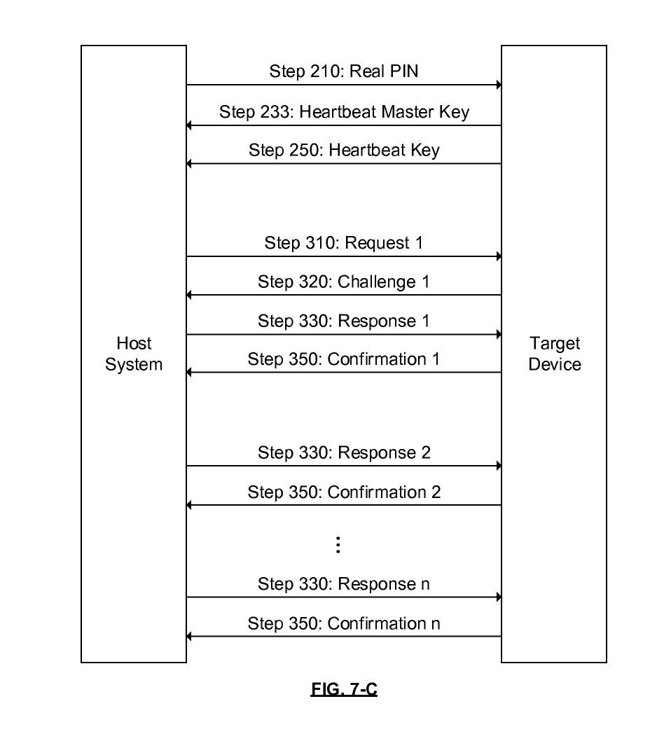

Reference is made to FIGS. 7-A to 7-C, which illustrate block diagrams of data transmitted between the host system and the target device. As can be seen in FIGS. 7-A to 7-C, the heartbeat key may not be transmitted after the initial authentication. In FIG. 7-A, each cryptographic heartbeat exchange includes a request for a challenge, a challenge, a response, and a confirmation. In FIG. 7-B, each cryptographic heartbeat exchange includes a challenge, a response, and a confirmation. In FIG. 7-C, the cryptographic heartbeat exchange includes a first request for a challenge, a first challenge, a first response, and a first confirmation, followed by a series of responses and confirmations. Each response in the series of responses may be generated based on the preceding response in the series.

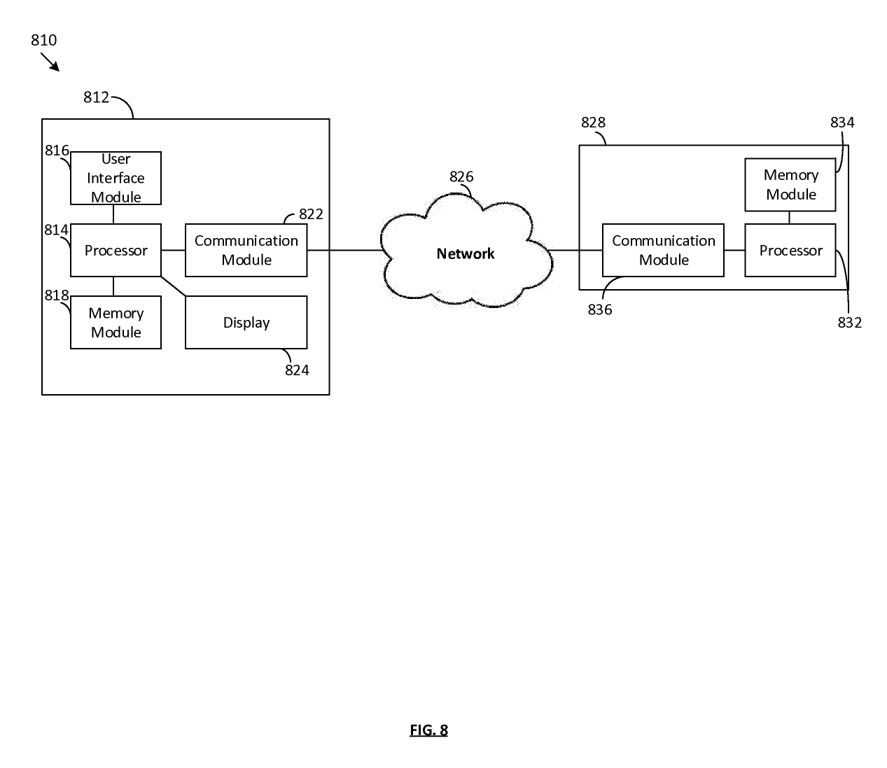

Reference is made to FIG. 8, which is a block diagram illustrating an example embodiment of system 810 for controlling access to target device 828 by host system 812. System 810 includes a target device 828, a network 826 and a host system 812.

Host system 812 includes a processor 814, a user interface module 816, a memory module 818, an output generation module 820, a communication port 822, and a display 824. Many components of the host system 812 can be implemented using a desktop computer, a laptop, a mobile device, a tablet, and the like.

Processor 814 controls the operation of host system 812 and can be any suitable processor, controller or digital signal processor that can provide sufficient processing power depending on the configuration, purposes and requirements of host system 812. For example, processor 814 may be a high performance general processor. In alternative embodiments, processor 814 may include more than one processor with each processor being configured to perform different dedicated tasks. In alternative embodiments, specialized hardware can be used to provide some of the functions of processor 814.

The user interface module 816 can include at least one of a mouse, a keyboard, a touch screen, a thumbwheel, a track-pad, a track-ball, a card-reader, voice recognition software, iris recognition hardware and software, fingerprint recognition hardware and software and the like, again depending on the particular implementation of the host system 812. In some cases, some of these components can be integrated with one another. The user interface module 816 may also include at least one of a microphone, a speaker and a printer, for example. The user interface module 816 can support various and different authentication inputs that allow users to input a password candidate in the form of an alphanumeric access code, a biometric scan (e.g. fingerprint or iris), using a smartcard, or using tokens, for example, alone or in conjunction with a trusted platform module (TPM) for additional security.

The memory module 818 can include RAM, ROM, one or more hard drives, one or more flash drives or some other suitable data storage elements such as disk drives, etc. The memory module 818 may be used to store an output generation record, possibly comprising an encrypted or scrambled authorized output.

Communication port 822 can include at least one of a serial port, a parallel port or a USB port that provides USB connectivity. The communication port 822 can also include at least one of an Internet, Local Area Network (LAN), Ethernet, Firewire, SATA, modem or digital subscriber line connection. Various combinations of these elements can be incorporated within the output communication module 822. In some cases, the communication port 822 can also include a wireless unit that can be used by the host system 812 to communicate with other devices or computers. The wireless unit can be a radio that communicates utilizing CDMA, GSM, GPRS or Bluetooth protocol according to standards such as IEEE 802.11a, 802.11b, 802.11g, or 802.11n.

The display 824 can be any suitable display that provides visual information depending on the configuration of the host system 812. For instance, the display 824 can be a cathode ray tube, a flat-screen monitor and the like if the host system 812 is a desktop computer. In other cases, the display 824 can be a display suitable for a laptop, tablet or handheld device such as an LCD-based display and the like.

The network 826 can be a communication network such as a wired or wireless connection to the internet and/or other types of computer or telecommunication networks. Those skilled in the art may also appreciate that network 826 may take the form of locally interconnected devices communicating over communications protocols such as SATA, Firewire and USB. The host system 812 and the target device 828 are operable to communicate using the network 826 using the above mentioned protocols and/or interfaces. In some cases, the target device 812 and the target device 828 can also communicate using a secure or encrypted connection such as by using HTTPS through a SSL/TSL tunnel.

The target device 828 includes a processor 832, a memory module 834, and a communication port 836. The target device memory module 834 and communication port 836 can be hardware or software modules substantially similar to the host system memory module 816 and the host system communication port 822, respectively, described above. The target device processor 832 controls the operation of the target device 828, and can be any suitable processor, controller or digital signal processor that can provide sufficient processing power such as those described herein with reference to the host system 814.

The present invention has been described here by way of example only. Various modification and variations may be made to these exemplary embodiments without departing from the spirit and scope of the invention, which is limited only by the appended claim.

1. A method of operating a computer component to control access to a first computer component by a second computer component, the method comprising:
determining if the second computer component is authorized to have access to the first computer component;
operating the first computer component to start a session if and only if the second computer component is authorized to have access to the first computer component;
generating session-specific access instructions and storing the session-specific access instructions at the first computer component and the second computer component, wherein the session-specific access instructions generated for the session are different from session-specific access instructions for accessing the first computer component generated for other sessions;
during the session, providing the second computer component with access to the first computer component;
during the session, operating the second computer component according to the session-specific access instructions;
operating the first computer component to monitor the second computer component during the session, including at some times when the second computer component is active but is not accessing the first computer component, for compliance with the session-specific access instructions;
determining a session termination event has occurred if the first computer component determines that the second computer component has failed to comply with the session specific instructions;
and,
terminating the session when the session termination event has occurred, wherein terminating the session blocks access to the first computer component by the second computer component.

2. The method of operating the computer component as defined in claim 1 further comprising defining a plurality of session termination events, wherein
during the session, operating the second computer component according to the session-specific access instructions comprises operating the second computer component to generate a response to send to the first computer component;
operating the first computer component to monitor the second computer component during the session for compliance with the session-specific access instructions comprises operating the first computer component to receive the response from the second computer component; and
at least one termination event comprises the first computer component not receiving the response from the second computer component that the first computer component is expecting to receive, such that the session is terminated if any termination event in the plurality of termination events occurs.

3. The method of operating the computer component as defined in claim 2 wherein at least one termination event in the plurality of termination events is indicative of a hostile computer component masquerading as the second computer component.

4. The method of operating the computer component as defined in claim 1 wherein:
the session-specific access instructions comprises session-specific response instructions for generating a session-maintaining response that is derivable based on the session-specific response instructions such that a derivable response indicates compliance with the session-specific response instructions; and
operating the first computer component to monitor the second computer component during the session further comprises:
generating at the second computer component a timewise series of responses in compliance with the session-specific response instructions and sending the timewise series of responses to the first computer component,
receiving at the first computer component a timewise series of responses from the second computer component, wherein each response in the timewise series of responses is derivable based on the response instructions, and
analysing each response in the timewise series of responses to determine if it is derivable based on the response instructions provided to the second computer component; and
the session termination event has occurred when each response in a threshold number of responses in the timewise series of responses is not derivable from the response instructions provided to the second computer component, the threshold number of responses being a positive integer.

5. The method of operating the computer component as defined in claim 4, wherein:
operating the first computer component to monitor the second computer component during the session further comprises sending at least one query from the first computer component to the second computer component,
each response in the timewise series of responses is derivable from the at least one query based on the response instructions,
analysing each response in the timewise series of responses to determine if it is derivable based on the session-specific response instructions provided to the second computer component comprises analysing each response in the timewise series of responses to determine if it is derivable from the at least one query based on the response instructions provided to the second computer component; and
the session termination event has occurred when the response in the timewise series of responses is not derivable from the at least one query based on the response instructions provided to the second computer component.

6. The method of operating the computer component as defined in claim 5, wherein
providing the session-specific response instructions to the second computer component comprises operating the first computer component to start the session by operating the first computer component to generate the session-specific response instructions and to send the response instructions to the second computer component.

7. The method of operating the computer component as defined in claim 5 wherein
the at least one query comprises a timewise series of queries;
the session-specific response instructions comprise a response timing requirement specifying a maximum permitted time interval for receiving each response in the timewise series of responses from the second computer component after sending a corresponding query in the timewise series of queries to the second computer component; and
the session termination event has occurred if a response in the timewise series of responses contravenes the response timing requirement based on the corresponding query in the timewise series of queries.

8. The method as defined in claim 4 wherein
the session-specific response instructions comprise a cryptographic key; and
each response in the timewise series of responses is derivable based on the response instructions using the cryptographic key.

9. The method as defined in claim 1 wherein the first computer component is a secure drive and the second computer component is a host computer system seeking access to data stored on the secure drive.

10. The method as defined in claim 5 wherein
operating the first computer component to monitor the second computer component during the session further comprises, prior to sending the at least one query from the first computer component to the second computer component, receiving at the first computer component a request from the second computer component for the at least one query; and
the session termination event comprises not receiving the request from the second computer component for the at least one query within a pre-determined period of time after starting the session.

11. The method of operating the computer component as defined in claim 4 wherein
the session-specific response instructions instruct the second computer component to determine a second computer component transaction count by, during the session, counting a number of transactions involving the first computer component and the second computer component, and to derive each response in the timewise series of responses based, in part, on the second computer component transaction count; and
analysing each response in the timewise series of responses to determine if it is derivable based on the session-specific response instructions provided to the second computer component comprises:
operating the first computer component to determine a first computer component transaction count by, during the session, counting the number of transactions involving the first computer component and the second computer component, and
determining if each response in the series of responses is derivable based on the first computer component transaction count.

12. The method of operating the computer component as defined in claim 9 wherein
the session-specific response instructions instruct the host computer system to determine a host computer system transaction count by, during the session, counting a number of read/write transactions involving the secure drive and the host computer system, and to derive each response in the timewise series of responses based, in part, on the host computer system transaction count; and
operating the first computer component to analyse each response in the timewise series of responses to determine if it is derivable based on the response instructions comprises:
operating the secure drive to determine a secure drive transaction count by, during the session, counting the number of read/write transactions involving the secure drive and the host computer system, and
determining if each response in the series of responses is derivable based on the secure drive transaction count.

13. A first computer component comprising:
a communication port for communicating with a second computer component;
a memory for storing restricted information, the memory comprising a non-transitory computer-readable storage medium for storing instructions;
a processor configured to execute the instructions, the instructions for
determining if the second computer component is authorized to have access to the restricted information stored on the memory;
operating the first computer component to start a session if and only if the second computer component is authorized to have access to the restricted information stored on the memory;
storing generated session-specific access instructions on the non-transitory computer-readable storage medium, wherein the session-specific instructions are also stored on the second computer component, wherein the session-specific access instructions generated for the session are different from session-specific access instructions for accessing the first computer component generated for other sessions;
during the session, providing the second computer component with access to the first computer component via the communication port;
operating the communication port to monitor the second computer component during the session, including at some times when the second computer component is active but is not accessing the first computer component, for compliance with the session-specific access instructions;
determining a session termination event has occurred if the second computer component has failed to comply with the session specific instructions; and,
terminating the session when the session termination event has occurred, wherein terminating the session blocks access to the restricted information stored on the memory by the second computer component.

14. The first computer component of claim 13 wherein the session termination event comprises a plurality of session termination events, and wherein
during the session, the second computer component operates according to the session-specific access instructions to generate a response to send to the communication port of the first computer component;
the processor is further configured for operating the communication port to receive the response from the second computer component to monitor the second computer component during the session for compliance with the session-specific access instructions; and
at least one termination event comprises the first computer component not receiving a response from the second computer component that the first computer component is expecting to receive, such that the session is terminated if any termination event in the plurality of termination events occurs.

15. The first computer component of claim 14 wherein at least one termination event in the plurality of termination events is indicative of a hostile computer component masquerading as the second computer component.

16. The first computer component of claim 13 wherein
the session-specific access instructions comprises session-specific response instructions for generating a session-maintaining response that is derivable based on the session-specific response instructions such that a derivable response indicates compliance with the session-specific response instructions; and
operating the processor and the communication port to monitor the second computer component further comprises:
configuring the communication port to receive a timewise series of responses generated by the second computer component;
configuring the processor to analyze each response in the timewise series of responses to determine if it is derivable based on the session-specific response instructions available to the processor; and
configuring the processor to determine that the session termination event has occurred when each response in a threshold number of responses in the timewise series of responses is not derivable based on the response instructions, the threshold number of responses being a positive integer.

17. The first computer component of claim 16 wherein
the communication port is further configured to transmit the session-specific response instructions and at least one query from the first computer component to the second computer component,
the processor is further configured to analyse each response in the timewise series of responses to determine if it is derivable from the at least one query based on the session-specific response instructions provided to the second computer component; and
the processor is further configured to determine that the session termination event has occurred when the response in the timewise series of responses is not derivable from the at least one query based on the session-specific response instructions provided to the second computer component.

18. The first computer component of claim 17 wherein the processor is configured to generate the session-specific response instructions and send the session-specific response instructions to the second computer component when starting the session.

19. The first computer component of claim 17 wherein
the at least one query comprises a timewise series of queries;
the session-specific response instructions comprise a response timing requirement specifying a maximum permitted time interval for receiving each response in the timewise series of response from the second computer component after sending a corresponding query in the timewise series of queries to the second computer component; and
the processor is further configured to determine that the session termination event has occurred if a response in the timewise series of responses contravenes the response timing requirement based on the corresponding query in the timewise series of queries.

20. The first computer component of claim 16 wherein
the session-specific response instructions comprise a cryptographic key; and,
each response in the timewise series of responses is derivable based on the response instructions using the cryptographic key.

21. The first computer component of claim 16 wherein
the first computer component is a secure drive; and
providing the second computer component with access to the first computer component during the session, comprises providing the second computer component with access to the restricted information stored on the memory during the session.

22. The first computer component of claim 17 wherein
operating the processor and the communication port to monitor the second computer component during the session further comprises, prior to sending the at least one query from the first computer component to the second computer component, receiving at the first computer component a request from the second computer component for the at least one query; and
the session termination event comprises not receiving the request from the second computer component for the at least one query within a pre-determined period of time after starting the session.

23. The first computer component of claim 16, wherein the processor is further configured to:
determine a first computer component transaction count by, during the session, counting a number of transactions involving the first computer component and the second computer component; and
analyze each response in the timewise series of responses to determine if it is derivable based on the response instructions and the first computer component transaction count.

24. The first computer component of claim 21, wherein:
the processor is further configured to determine a secure drive transaction count by, during the session, counting the number of read/write transactions involving the secure drive and the second computer component; and
the processor is further configured to analyze each response in the timewise series of responses to determine if it is derivable based on the session-specific response instructions and the secure drive transaction count.

25. The method of operating the computer component as defined in claim 1 wherein, at other times during the session when the second computer component is active and not accessing the first computer component, the first computer component is not monitoring the second computer component for compliance with the session-specific access instructions.

26. The first computer component of claim 13 wherein according to the instructions for operating the communication port, at other times during the session when the second computer component is active and not accessing the first computer component, the first computer component is not monitoring the second computer component for compliance with the session-specific access instructions.
